(19) United States
(12) Patent Application Publication
(10) Pub. No.: US 2022/0305509 A1
(43) Pub. Date: Sep. 29, 2022

(54) MICRO-MIST DUST SUPPRESSION DEVICE FOR COAL STORAGE EUROSILO

(71) Applicant: HUANENG POWER INTERNATIONAL, INC. SHANGHAI SHIDONGKOU FIRST POWER PLANT, Shanghai (CN)

(72) Inventors: Xiao ZHANG, Shanghai (CN); Xin HU, Shanghai (CN); Ping ZHU, Shanghai (CN)

(21) Appl. No.: 17/447,429

(22) Filed: Sep. 12, 2021

(30) Foreign Application Priority Data
Mar. 29, 2021 (CN) 202110336822.7

(51) Int. Cl. B05B 7/26; B05B 3/12; B05B 15/40; B65G 69/18

(52) U.S. Cl. CPC B05B 7/262; B05B 3/12; B05B 15/40; B65G 69/188

(57) ABSTRACT

Provided is a micro-mist suppression device for a coal storage Eurosilo for suppressing dust within the Eurosilo, comprising a micro-mist dust suppression host and a water-gas supply module and a micro-mist generation module connected with the micro-mist dust suppression host; the water-gas supply module includes a water supply unit and an gas supply unit; the water supply unit includes an annular water tank, a variable frequency pump and a water filter which are successively connected, the micro-mist suppression host is connected with the water filter and the variable frequency pump; the gas supply unit includes an air compressor and an air reservoir, the air compressor, the air reservoir and the micro-mist dust suppression host are successively connected; the micro-mist generation module includes a first water-gas hose, a feed assembly and a water-gas distributor which are successively connected, the water-gas distributor is connected with a micro-mist spray head

### CROSS-REFERENCE TO RELATED APPLICATIONS

This application claims priority benefits to Chinese Patent Application No. 202110336822.7, filed on Mar. 29, 2021. The contents of the aforementioned application are incorporated herein by reference.

### TECHNICAL FIELD

The present disclosure relates to the technical field of coal storage, and in particular to a micro-mist dust suppression device for a coal storage Eurosilo.

### BACKGROUND

Eurosilo coal storage is the latest environmentally friendly coal storage method in China, the coal types in foreign Eurosilo coal storage are quite different from those in China, there are few powdery small particles in foreign coal types, when coal enters the Eurosilo and is taken out of the Eurosilo, less dust is produced, therefore, foreign Eurosilo coal storage is not equipped with any equipment to suppress dust. Domestic coal enterprises for power generation generally use coal with a high proportion of powdery particles, which is easy to produce dust during conveying and transportation; when the Eurosilo stores coal, there are two processes: coal entering and stacking and coal taking and leaving, in which the dust generated during coal entering is the largest.

As shown in FIG. 1, the coal falls into the central telescopic discharge pipe 6 from the feed inlet 2 at the top of the Eurosilo and is output from the lower end of the central telescopic discharge pipe 6 to the screw machine 9, and the coal is stacked by the screw machine 9. The coal stacking height in the barrel 1 of the Eurosilo can reach more than 40 meters, when the coal level is low, the coal falls directly from the top of the barrel 1 of the Eurosilo to the screw machine 9, and the drop is also close to 40 meters, this gap causes the falling coal to have a higher speed, the coal having the higher speed will drive the surrounding air to have a strong flow, and small particles of coal will float, thus resulting in larger dust. When such coal enters the Eurosilo, the whole space of the Eurosilo will be filled with larger coal dust, and the floating dust will easily produce unsafe hazards such as deflagration.

### SUMMARY

The disclosure aims at overcoming the defects of the prior art and provides a micro-mist dust suppression device for a coal storage Eurosilo, which can effectively suppress dust in the Eurosilo and has good safety.

The objective of the present disclosure can be achieved by the following technical solution:

The top of the barrel of the Eurosilo is provided with a coal transporting trestle, a belt conveyor is arranged in the coal transporting trestle, the barrel is provided with a revolving trestle, a central telescoping discharge pipe, a helical frame, and an A-type frame, the helical frame and the A-type frame are hung on the revolving trestle by a lifting wire rope and a hoisting machine, the helical frame and the A-type frame are connected. A screw machine is arranged on the helical frame, the revolving trestle is arranged on an annular track on the inner side wall of the barrel by a walking mechanism, the center of the revolving trestle is provided with a center hoisting platform, the central telescopic discharge pipe is coaxial with the barrel, and passes through the central hoisting platform, the upper end of the central telescoping discharge pipe is aligned with a feed inlet on the coal transporting trestle, the lower end is connected with the screw machine through a guide chute, and a dust cover of the guide chute is arranged on the guide chute, the coal is conveyed by the belt conveyor at the feed inlet to the feed inlet and then is conveyed to the screw machine by the central telescopic discharge pipe, the coal falls from a discharge port of the screw machine into the barrel. The screw machine rotates with the rotation of the revolving trestle, and simultaneously does lifting movement by the lifting wire rope to make the coal stored uniformly within the barrel. The central telescopic discharge pipe is formed by concentrically connecting several segments of circular tubes of different diameters, the two ends of each segment of circular tube are provided with steps of different diameters, such that two adjacent sections of circular tubes are hooked to each other and slide relatively along the axial direction of the circular tube, the several sections of the circular tubes are joined along one axis, the sections of the circular tubes are expanded or contracted section by section as the distance between the two ends of the central telescopic discharge pipe is extended or shortened, so that the distance between the two ends of the central telescopic discharge pipe can vary depending on the distance between the revolving trestle and the helical frame.

A micro-mist dust suppression device for a coal storage Eurosilo for suppressing dust within the Eurosilo, including a micro-mist dust suppression host, a water-gas supply module and a micro-mist generation module;

the water-gas supply module includes a water supply unit and a gas supply unit;

the water supply unit includes an annular water tank, a variable frequency pump and a water filter which are successively connected, and the micro-mist dust suppression host is connected with the water filter and the variable frequency pump;

the gas supply unit includes an air compressor and an air reservoir, the air compressor, the air reservoir and the micro-mist dust suppression host are successively connected; and

the micro-mist generation module includes a first water-gas hose, a feed assembly, a water-gas distributor and a micro-mist spray head which are successively connected.

Further, the variable frequency pump, the water filter, the micro-mist dust suppression host, the air reservoir, and the air compressor are arranged on the revolving trestle of the Eurosilo.

Further, the feed assembly includes a water-gas metal pipe, a metal water supply pipe and a metal gas supply pipe, the water-gas metal pipe is fixed on an A-type frame of the Eurosilo, the metal water supply pipe and the metal gas supply pipe are arranged on a helical frame of the Eurosilo, the metal water supply pipe and the metal gas supply pipe are connected with the water-gas metal pipe via a pipe joint, and the water-gas metal pipe is connected with the first water-gas hose.

Further, the annular water tank is fixedly connected with a coal transporting trestle of the Eurosilo by a water groove holder and coaxially sleeved on the outside of a central telescopic discharge pipe of the Eurosilo, the annular water tank does not rotate along with the revolving trestle, and a water groove inlet pipe is connected between the coal transporting trestle and the annular water tank.

The annular water tank includes an annular water groove and a shade on the annular water groove, and the shade has a spire feature, can completely cover the upper part of the annular water groove to prevent coal power stacking. The micro-mist dust suppression device further includes a water groove cleaner, and an annular opening is arranged between the shade and the annular water groove. The water groove cleaner includes a connecting rod, one end of the connecting rod is provided with a sweeping plate and is inserted into the annular water groove through the annular opening and the other end is fixedly connected with a central revolving platform of the Eurosilo, and the variable frequency pump is connected with a variable frequency pump inlet pipe which is inserted into the annular water groove through the annular opening.

The annular water groove is provided with a water groove drain outlet at the bottom thereof, and the water groove drain outlet is provided with a water groove drain valve at the end thereof.

Further, the micro-mist dust suppression device further includes a water tank gauge, an inner side plate of the annular water groove is communicated with a gauge pipe, and the water tank gauge is arranged on the gauge pipe to monitor the water level in the annular water groove, which is convenient to control the water outlet and replenishment of the annular water groove.

Further, the water-gas metal pipe is provided with a pressure transmitter connected with the micro-mist dust suppression host. The pressure transmitter is connected with the micro-mist dust suppression host so as to feed back a water pressure signal. The micro-mist dust suppression host adjusts the water supply pressure at the outlet of the variable frequency pump according to the water pressure signal to satisfy the requirement of the water-gas distributor for the water pressure, and the dedusting effect is stable.

Further, the micro-mist dust suppression device further includes a constant torque reel arranged on the revolving trestle of the Eurosilo, and the first water-gas hose is coiled on the constant torque reel. The micro-mist dust suppression host is located on the revolving trestle, while the water-gas metal pipe is fixed to the A-type frame, the spacing between the A-type frame and the revolving trestle changes when the Eurosilo is working, the constant torque reel has a constant torque, when the pulling force acting on the first water-gas hose is greater than the constant torque of the constant torque reel, the first water-gas hose is drawn out, when the pulling force acting on the first water-gas hose is less than the constant torque of the constant torque reel, the first water-gas hose is brought into the constant torque reel, the first water-gas hose has a telescopic function and is capable of synchronously adapting to the spacing between the helical frame and the revolving trestle so that the first water-gas hose remains vertically tensioned all the time, the first water-gas hose is prevented from being hooked because the hose is too long or from being pulled off because the hose is too short, and good safety is ensured.

Compared to the prior art, the present disclosure has the following beneficial effects:

(1) The present disclosure includes a micro-mist dust suppression host and a water-gas supply module and a micro-mist generation module connected with the micro-mist dust suppression host, the water-gas supply module includes a water supply unit and a gas supply unit, the water supply unit includes an annular water tank, a variable frequency pump and a water filter which are successively connected, the micro-mist dust suppression host is connected with the water filter and the variable frequency pump; the gas supply unit includes an air compressor and an air reservoir, the air compressor, the air reservoir, and the micro-mist dust suppression host are successively connected, the micro-mist generation module includes a first water-gas hose, a feed assembly and a water-gas distributor which are successively connected, a micro-mist spray head is connected with the water-gas distributor, the micro-mist spray head is arranged on the helical frame of the Eurosilo. Due to the coal storage means of the Eurosilo, dust is easily generated when the coal enters the Eurosilo and falls down, and water mist is generated by the micro-mist spray head on the helical frame, which can effectively suppress the dust and improve the operation safety of the Eurosilo during coal storage with large dust.

(2) The annular water tank of the present disclosure is fixedly connected with the coal transporting trestle of the Eurosilo through a water groove holder, and coaxially sleeved on the outside of the central telescopic discharge pipe of the Eurosilo, the annular water tank does not rotate with the revolving trestle, the annular water tank includes an annular water groove and a shade on the annular water groove, and the shade completely covers the upper part of the annular water groove, and the dustproof property is good. An annular opening is arranged between the shade and the annular water groove. One end of the connecting rod is provided with a sweeping plate and is inserted into the annular water groove through the annular opening and the other end is fixedly connected with a central revolving platform of the Eurosilo. The sweeping plate rotates along with the coal transporting trestle in the annular water groove and can automatically clean the coal slime in the annular water groove. The annular water groove is provided with a water groove drain outlet at the bottom thereof, the sweeping plate rotates along with the central revolving platform and sweeps the coal slime into the water groove drain outlet. The coal slime is discharged by opening the water groove drain valve periodically, the operation is simple, the layout cost is low and the automation degree is high.

(3) A water groove inlet pipe is connected between the coal transporting trestle and the annular water tank, a water source within the coal transporting trestle is delivered into the annular water tank through the water groove inlet pipe, an annular opening is arranged between the shade and the annular water tank, while the variable frequency pump is arranged on the coal transporting trestle to rotate with the coal transporting trestle, a variable frequency pump inlet pipe is inserted into the annular water tank through the annular opening to meet the demand of water supply of the variable frequency pump within 360 degrees.

(4) An inner side plate of the annular water groove is communicated with a gauge pipe, and the water tank gauge is arranged on the gauge pipe to monitor the water level within the annular water groove to facilitate control of water outlet and replenishment of the annular water groove.

(5) The constant torque reel of the present disclosure is arranged on the revolving trestle of the Eurosilo, and the first water-gas hose is coiled on the constant torque reel. The micro-mist dust suppression host is located on the revolving trestle, while the water-gas metal pipe is fixed to the A-type frame, the spacing between the A-type frame and the revolving trestle changes when the Eurosilo is working, the constant torque reel has a constant torque, when the pulling force acting on the first water-gas hose is greater than the constant torque of the constant torque reel, the first water-gas hose is drawn out, when the pulling force acting on the first water-gas hose is less than the constant torque of the constant torque reel, the first water-gas hose is brought into the constant torque reel, the first water-gas hose has a telescopic function and is capable of synchronously adapting to the spacing between the helical frame and the revolving trestle so that the first water-gas hose remains vertically tensioned all the time, the first water-gas hose is prevented from being hooked because the hose is too long or from being pulled off because the hose is too short, good safety is ensured.

(6) A pressure transmitter connected with the micro-mist dust suppression host is arranged on the first water-gas hose. Since the height of the revolving trestle is unchanged, the operational height of the helical frame varies, therefore the water pressure inside the water-gas metal pipe changes constantly, thus causing deterioration of the atomization effect of the micro-mist spray head, and in turn, the dust suppression effect is worsened, and as a result, a pressure transmitter is arranged on the water-gas metal pipe, the pressure transmitter is connected with a micro-mist dust suppression host for feeding back a water pressure signal, the micro-mist dust suppression host adjusts the outlet water supply pressure of the variable frequency pump according to the water pressure signal to meet the water pressure requirement of the water-gas distributor and the dust suppression effect is stabilized.

### BRIEF DESCRIPTION OF THE DRAWINGS

FIG. 1 is a structural schematic diagram of an Eurosilo.

FIG. 2 is a structural schematic diagram of a micro-mist dust suppression device.

FIG. 3 is a structural schematic diagram of an annular water tank.

FIG. 4 is a schematic diagram of the position of a communication port of a gauge pipe.

FIG. 5 is a schematic diagram of a mounting position of a tank cleaner.

FIG. 6 is a structural schematic diagram of the tank cleaner.

FIG. 7 is a schematic diagram of the connection of a water-gas supply module and a micro-mist dust suppression host.

FIG. 8 is a structural schematic diagram of a water-gas distributor.

FIG. 9 is a schematic diagram of a placement position of the micro-mist dust suppression device on the Eurosilo.

FIG. 10 is a structural block diagram of the micro-mist dust suppression device.

### DESCRIPTION FOR SYMBOLS IN THE ACCOMPANYING DRAWINGS

1. Barrel, 2. Feed inlet 3. Coal transporting trestle, 4. Revolving trestle, 5. Walking mechanism, 6. Central telescopic discharge pipe, 7. Lifting wire rope, 8. Helical frame, 9. Screw machine, 10. Dust cover of guide chute, 11. A-type frame, 12. Center hoisting platform, 13. Central revolving platform, 14. Water groove inlet pipe, 15. Micro-mist spray head, 16. Water groove drain valve, 17. Hoisting machine, 18. Metal water supply pipe, 19. Metal gas supply pipe, 20. Water inlet of water groove, 21. Annular water tank, 22. Tank cleaner, 24. Variable frequency pump, 25. Water filter, 26. Constant torque reel, 27. Micro-mist dust suppression host, 28. Air reservoir, 29. Air compressor, 30. First water-gas hose, 31. Pressure transmitter, 32. Water-gas metal pipe, 33. Water-gas distributor, 34. Second water-gas hose, 35. Pipe joint, 36. Water groove drain outlet, 37. Water tank gauge, 38. Air inlet, 39. Communication port of gauge pipe, 40. Water groove holder, 41. Gauge pipe, 42. Variable frequency pump inlet pipe, 211. Outer side plate, 212. Inner side plate, 213. Shade, 221. Sweeping plate, 222. Fixing bolt, 223. Connecting rod.

### DETAILED DESCRIPTION

The present disclosure will now be described in detail with reference to the accompanying drawings and specific embodiments. While the present embodiments are carried out in light of the present technical solution, detailed embodiments and specific operating procedures are given, the scope of protection of the present disclosure is not limited to the embodiments described below.

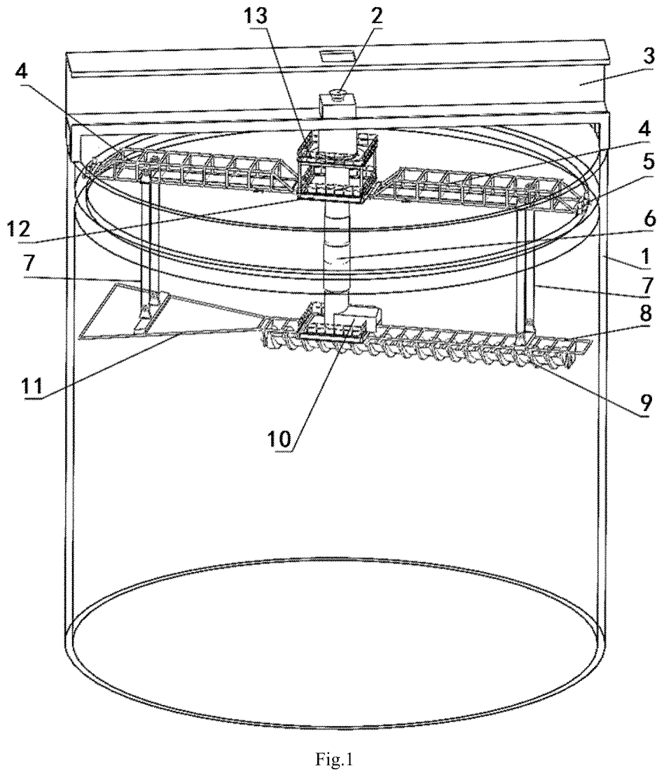

As shown in FIG. 1, the barrel 1 of the Eurosilo is provided at the top with a coal transporting trestle 3, a belt conveyor is arranged within the coal transporting trestle 3, a revolving trestle 4, a central telescopic discharge pipe 6, a helical frame 8 and an A-type frame 11 are arranged in the barrel 1, the helical frame 8 and the A-type frame 11 are hung on the revolving trestle 4 by a lifting wire rope 7 and a hoisting machine, the helical frame 8 and the A-type frame 11 are connected. A screw machine 9 is arranged on the helical frame 8, the revolving trestle 4 is arranged on an annular track on the inner side wall of the barrel 1 by a walking mechanism 5, the center of the revolving trestle 4 is provided with a center hoisting platform 12, the central telescopic discharge pipe 6 is coaxial with the barrel 1, and passes through the central hoisting platform 12, the upper end of the central telescoping discharge pipe 6 is aligned with a feed inlet 2 on the coal transporting trestle 3, the lower end is connected with the screw machine 9 through a guide chute, and a dust cover of the guide chute 10 is arranged on the guide chute, the coal is conveyed by the belt conveyor at the feed inlet 2 to the feed inlet 2 and then is conveyed to the screw machine 9 by the central telescopic discharge pipe 6, the coal falls from a discharge port of the screw machine 9 into the barrel 1. The screw machine 9 rotates with the rotation of the revolving trestle 4, and simultaneously does lifting movement by the lifting wire rope 7 to make the coal stored uniformly within the barrel 1. The central telescopic discharge pipe 6 is concentrically connected by several segments of circular tubes of different diameters, the two ends of each segment of circular tube are provided with steps of different diameters, such that two adjacent sections of circular tubes are hooked to each other and slide relatively along the axial direction of the circular tube, the several sections of the circular tubes are joined along one axis, the sections of the circular tubes are expanded or contracted section by section as the distance between the two ends of the central telescopic discharge pipe 6 is extended or shortened, so that the distance between the two ends of the central telescopic discharge pipe 6 can vary depending on the distance between the revolving trestle 4 and the helical frame 8.

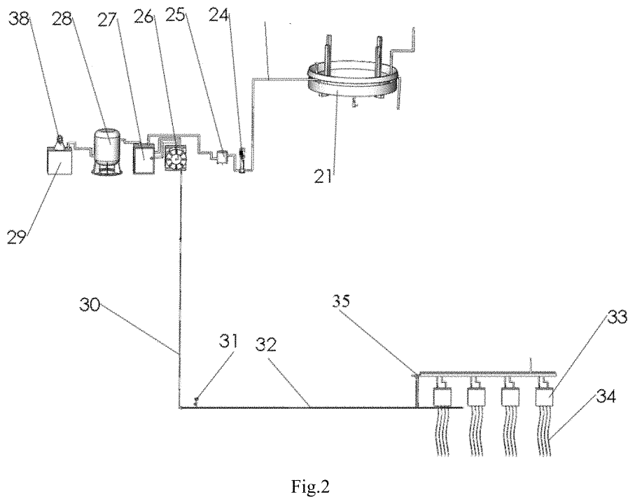

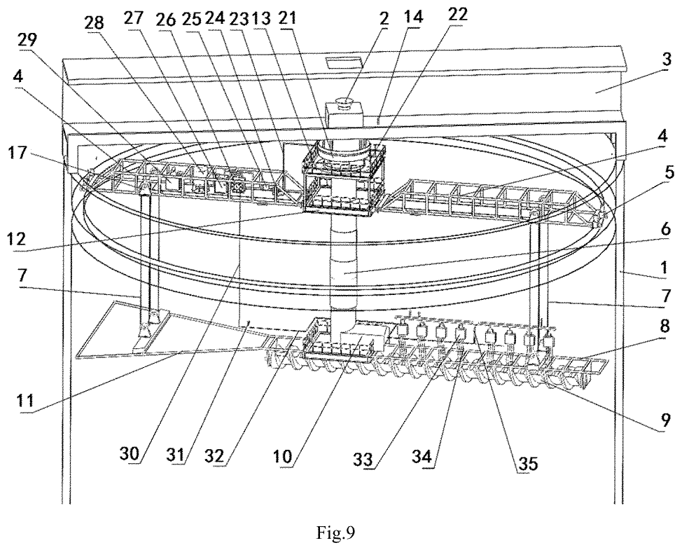

The micro-mist dust suppression device for a coal storage Eurosilo, as shown in FIG. 2 and FIG. 9, includes a micro-mist dust suppression host 27 and a water-gas supply module and a micro-mist generation module connected with the micro-mist dust suppression host 27;

The micro-mist dust suppression host 27 includes an electrical control system, an operating interface, various types of water-gas regulating valves and sensors, which is known in the art.

The water-gas supply module includes a water supply unit and a gas supply unit;

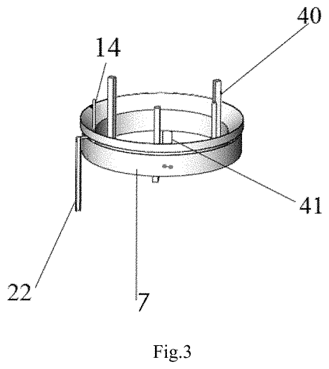

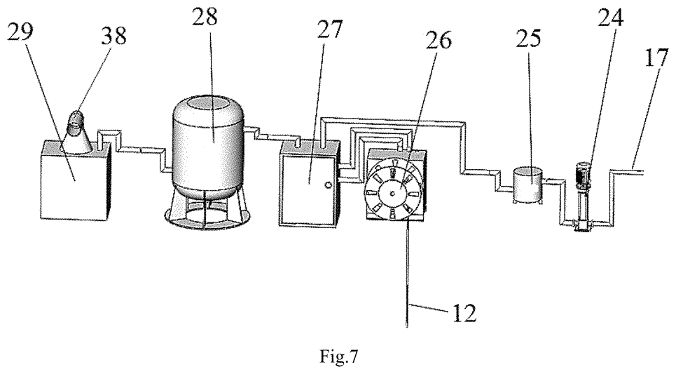

As shown in FIG. 2, FIG. 3, and FIG. 7, the water supply unit includes an annular water tank 21, a variable frequency pump 24 and a water filter 25 which are successively connected, the water filter 25 is connected with the micro-mist dust suppression host 27, the annular water tank 21 is configured to store water and the water in the annular water tank 21 is output by the variable frequency pump 24 and is filtered by the water filter 25, and then is delivered to the micro-mist dust suppression host 27;

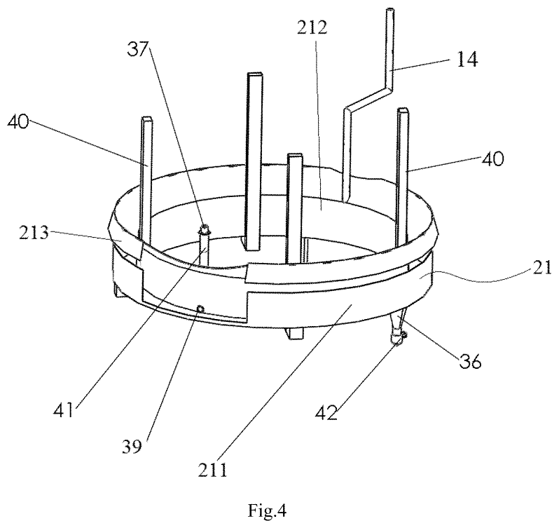

As shown in FIGS. 3, 4 and 5, the annular water tank 21 is fixed at the bottom of the coal transporting trestle 3 by four water groove holders 40, the water groove holder 40 is L-shaped, and the four water groove holders 40 are disposed symmetrically about the axis of the annular water tank 21 and hold the bottom of the annular water tank 21, the annular water tank is coaxially sleeved on the outside of the central telescopic discharge pipe 6 and does not rotate with the revolving trestle 4, the water source within the coal transporting trestle 3 is delivered through the water groove inlet pipe 14 into the annular water tank 21, and the annular water tank 21 can meet the demand of water supply of the variable frequency pump 24 within 360 degrees.

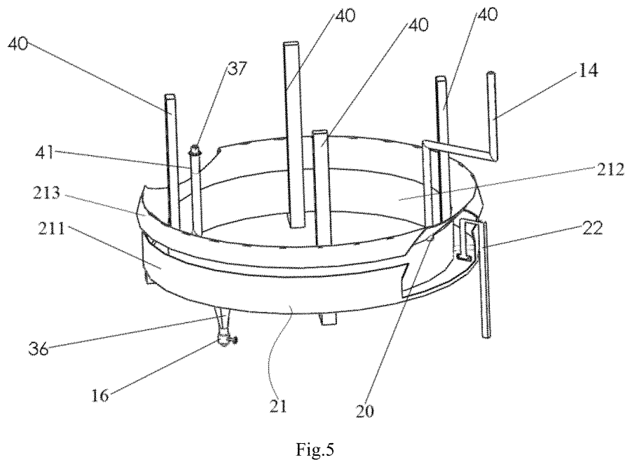

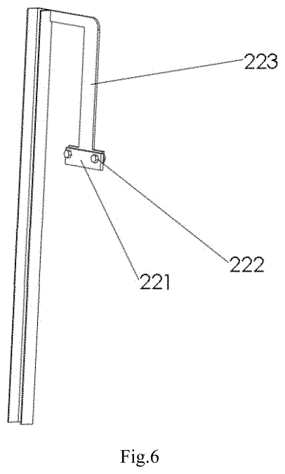

The annular water tank 21 includes an annular water groove and a shade 213, the annular water tank 21 is provided with a tank cleaner 22 and a gauge pipe 41, the shade 213 completely covers the upper part of the annular water groove, the water groove inlet pipe 14 is connected with the shade 213, an annular opening is arranged between the shade 213 and the outer side plate 211 of the annular water groove. As shown in FIGS. 5 and 6, the tank cleaner 22 includes a barb-shaped connecting rod 223, the central revolving platform 13 is arranged on the central hoisting platform 12, and one end of the connecting rod 223 is fixed with the central revolving platform 13 and the other end is connected with the sweeping plate 221 by a fixing bolt 222 and extends into the annular water groove through an annular opening, and the variable frequency pump inlet pipe 42 is connected with the variable frequency pump 24 and extends into the annular water groove through the annular opening.

The sweeping plate 221 is in contact with the bottom of the annular water groove, the powder coal within the barrel 1 passes through the annular opening into the annular water groove, and is deposited in the bottom of the annular water groove to form the coal slime, the sweeping plate 221 is of a flexible wear material, the annular water groove is provided with a water groove drain outlet 36 at the bottom thereof, the water groove drain outlet 36 is provided with a water groove drain valve 16 at the end thereof, the sweeping plate 221 rotates along with the central revolving platform 13 and sweeps the coal slime into the water groove drain outlet 36. The coal slime is discharged by opening the water groove drain valve 16 periodically, and the operation is simple.

Depending on the direction of rotation of the revolving trestle, a water pipe outlet between the annular water tank 21 and the variable frequency pump 24 is located in front of the sweeping plate 221, thus ensuring that the suspended coal slime produced by sweeping of the sweeping plate 221 is not sucked in by the variable frequency pump 24.

The gauge pipe 41 is communicated with the annular water groove within the annular water tank 21 through the communication port 39 of the gauge pipe on the inner side plate 212, a water tank gauge 37 is arranged within the gauge pipe 41 for detecting the water level within the annular water tank 21, an input stop water level, a replenishment water level, and an output stop water level are set from large to small, the variable frequency pump 24 is turned off when the water level is below the output stop water level, the annular water tank 21 is replenished with water when the water level is between the replenishment water level and the output water output level, and water replenishment to the annular water tank 21 is stopped when the water level is greater than the input stop water level.

The gas supply unit includes an air compressor 29 and an air reservoir 28, the air compressor 29, the air reservoir 28 and the micro-mist dust suppression host 27 are connected in sequence by a gas pipe, air is drawn through the air inlet 38 of the air compressor 29, in order to ensure that the drawn air is relatively clean and the concentration of coal dust at the top of the barrel 1 is low, a filter screen is installed at the air inlet 38 and the air inlet 38 is enabled to be close to the top of the barrel 1, and the air compressor 29 employs a screw pump.

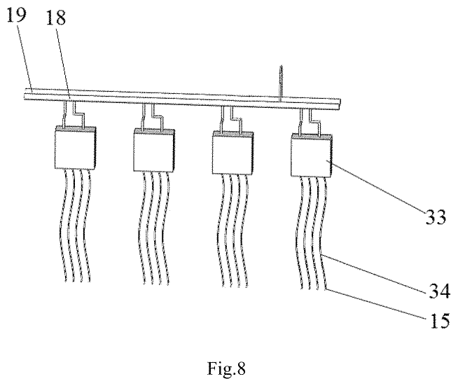

The micro-mist generation module includes a first water-gas hose 30, a supply assembly, water-gas distributors 33, and micro-mist spray heads 15 which are successively connected, the feed assembly includes a water-gas metal pipe 32, a metal water supply pipe 18 and a metal gas supply pipe 19, and there are a plurality of water-gas distributors 33. As shown in FIG. 8, four micro-mist spray heads 15 are connected with each water-gas distributor 33 via a second water-gas hose 34, the micro-mist dust suppression host 27, the first water-gas hose 30 and the water-gas metal pipe 32 are successively connected, the water-gas metal pipe 32 is fixed to the A-type frame 11, the metal water supply pipe 18 and the metal gas supply pipe 19 are connected with the water-gas metal pipe 32 by a pipe joint 35, the water-gas distributor 33 is connected with the metal water supply pipe 18 and to the metal gas supply pipe 19, the metal water supply pipe 18, the metal gas supply pipe 19 and the water gas distributors 33 are fixed to the helical frame 8;

A sensor for detecting water pressure and air pressure is connected with the water-gas distributor 33, and is connected with the micro-mist dust suppression master 27, and a valve set for manually regulating air pressure and water pressure is arranged on the water-gas distributor 33 to directly regulate water and gas pressures and flow to the micro-mist spray head 15.

Since the height of the revolving trestle 4 is unchanged, the operational height of the helical frame 8 varies, the water pressure inside the water-gas metal pipe 32 is thus constantly changing, causing deterioration of the atomization effect of the micro-mist spray heads 15, and in turn, the dust suppression effect is worsened, hence, the pressure transmitter 31 is arranged on the water-gas metal pipe 32, and the pressure transmitter 31 is electrically connected with the micro-mist dust suppression master 27 for feeding back the water pressure signal, and the micro-mist dust suppression master 27 adjusts the outlet water supply pressure of the variable frequency pump 24 according to the water pressure signal to meet the water pressure requirement of the water-gas distributor 33.

The revolving trestle 4 is symmetrical about the central hoisting platform 12, since the weight of the helical frame 8 and the screw machine 9 is greater than that of the A-type frame 11, the revolving trestle 4 is subjected to a relatively small load on the revolving trestle 4, so the variable frequency pump 24, the water filter 25, the micro-mist dust suppression host 27, the air reservoir 28 and the air compressor 29 are arranged on the revolving trestle 4 and on the same side of the central hoisting platform 12 as the A-type frame 11, with less force impact on the structure of the Eurosilo, thus guaranteeing safe operation of the Eurosilo.

Since the spacing between the helical frame 8 and the revolving trestle 4 needs to adapt to the stacking height of the coal stack within the barrel 1, the spacing may change, the constant torque reel 26 is thus arranged on the first water-gas hose 30 and is located on the revolving trestle 4, and on the same side of the central hoisting platform 12 with the A-type frame 11. The constant torque reel 26 includes a motor, a hysteresis coupling and a drum which are successively connected, the first water-gas hose 30 is coiled on the constant torque reel 26, to play a role of contraction. When the pulling force acting on the first water-gas hose 30 is greater than the constant torque of the constant torque reel 26, the first water-gas hose 30 is drawn out, and when the pulling force acting on the first water-gas hose 30 is less than the constant torque of the constant torque reel 26, the first water-gas hose 30 is brought into the constant torque reel 26, the first water-gas hose 30 has a telescoping function and is able to synchronously adapt to the spacing between the helical frame 8 and the revolving trestle 4, so that so that the first water-gas hose 30 remains vertically tensioned all the time, the first water-gas hose is prevented from being hooked because the hose is too long or from being pulled off because the hose is too short, and good safety is ensured.

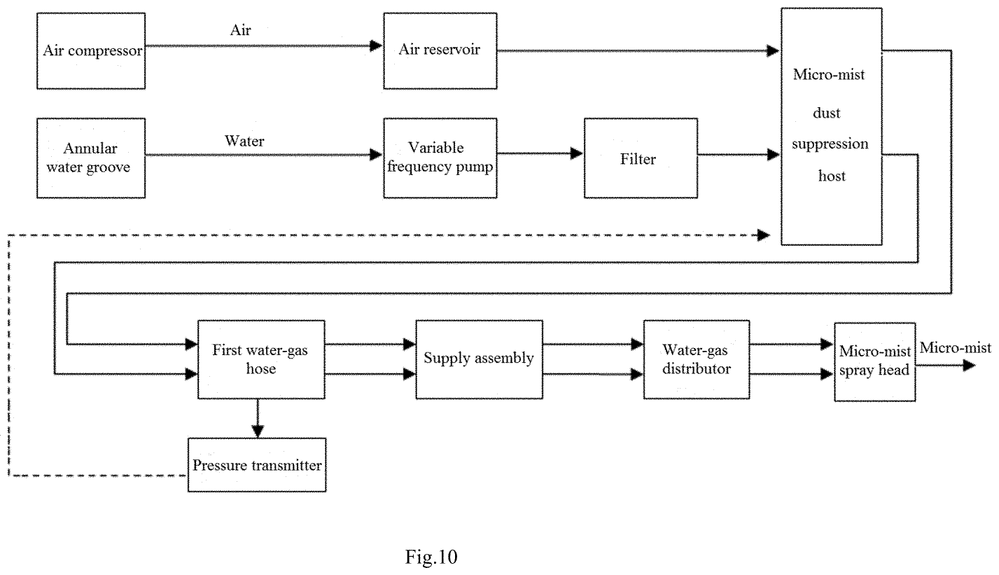

As shown in FIG. 10, the working process of the micro-mist dust suppression device is specifically as follows:

The air compressor 29 compresses air into the air reservoir 28, then the air reservoir 28 delivers air to the micro-mist dust suppression host 27, and the water in the annular water tank 21 is output through the variable frequency pump 24 and filtered through the water filter 25 and delivered to the micro-mist dust suppression host 27;

The micro-mist suppression master 27 delivers water to the water gas distributor 33 through the first water-gas hose 30, the water-gas metal pipe 32, the metal water supply pipe 18 and the metal gas supply pipe 19, the micro-mist spray head 15 generates the water mist with a water particle size of less than 10 microns, the micro-mist spray heads 15 are arranged above the screw machine 9 and the guide trough and at the acceptance point, hence the sprayed water mist can sufficiently cover the entire area of coal stacking, the raised coal dust is directly covered by the water mist, as there is a limited diffusion area inside the Eurosilo, the air flow carrying water droplets is mixed with coal dust together, which improves the adsorption efficiency of water droplets, increases the dust reduction effect, and effectively inhibits the dust generated when coal enters the Eurosilo for stacking.

The present embodiment provides a micro-mist dust suppression device for a coal storage Eurosilo, which can adapt to the structure and operation mode of the Eurosilo, solves the problem of dust generation during the operation of the Eurosilo, and improves the operation safety of the Eurosilo when storing coal with large dust.

Preferred embodiments of the present disclosure are described in detail above. It should be understood that a number of modifications and variations in accordance with the concepts of the present disclosure can be made without creative effort by those of ordinary skill in the art. Therefore, any technical solution that can be obtained by logical analysis, reasoning or limited experiments based on the prior art according to the idea of the present disclosure should be within the scope of protection determined by the claims.

We claim:

1. A micro-mist dust suppression device for a coal storage Eurosilo for suppressing dust within the Eurosilo, comprising a micro-mist dust suppression host (27), a water-gas supply module and a micro-mist generation module; wherein
the water-gas supply module comprises a water supply unit and a gas supply unit;
the water supply unit comprises an annular water tank (21), a variable frequency pump (24) and a water filter (25) which are successively connected, and the micro-mist dust suppression host (27) is connected with the water filter (25) and the variable frequency pump (24);
the gas supply unit comprises an air compressor (29) and an air reservoir (28), the air compressor (29), the air reservoir (28) and the micro-mist dust suppression host (27) are successively connected; and
the micro-mist generation module comprises a first water-gas hose (30), a feed assembly, a water-gas distributor (33) and a micro-mist spray head (15) which are successively connected.

2. The micro-mist dust suppression device for a coal storage Eurosilo of claim 1, wherein the annular water tank (21) is fixedly connected with a coal transporting trestle (3) of the Eurosilo by a water groove holder (40) and coaxially sleeved on the outside of a central telescopic discharge pipe (6) of the Eurosilo, and a water groove inlet pipe (14) is connected between the coal transporting trestle (3) and the annular water tank (21).

3. The micro-mist dust suppression device for a coal storage Eurosilo of claim 1, wherein the annular water tank (21) comprises an annular water groove and a shade (213) on the annular water groove, and the shade (213) completely covers the upper part of the annular water groove.

4. The micro-mist dust suppression device for a coal storage Eurosilo of claim 3, further comprising a water groove cleaner (22), wherein
an annular opening is arranged between the shade (213) and the annular water groove,
the water groove cleaner (22) comprises a connecting rod (223), one end of the connecting rod (223) is provided with a sweeping plate (221) and is inserted into the annular water groove through the annular opening and the other end is fixedly connected with a central revolving platform (13) of the Eurosilo, and
the variable frequency pump (24) is connected with a variable frequency pump inlet pipe (42) which is inserted into the annular water groove through the annular opening.

5. The micro-mist dust suppression device for a coal storage Eurosilo of claim 3, wherein the annular water groove is provided with a water groove drain outlet (36) at the bottom thereof, and the water groove drain outlet (36) is provided with a water groove drain valve (16) at the end thereof.

6. The micro-mist dust suppression device for a coal storage Eurosilo of claim 3, further comprising a water tank gauge (37), an inner side plate (212) of the annular water groove being communicated with a gauge pipe (41), and the water tank gauge (37) being arranged on the gauge pipe (41).

7. The micro-mist dust suppression device for a coal storage Eurosilo of claim 1, wherein the variable frequency pump (24), the water filter (25), the micro-mist dust suppression host (27), the air reservoir (28) and the air compressor (29) are arranged on a revolving trestle (4) of the Eurosilo.

8. The micro-mist dust suppression device for a coal storage Eurosilo of claim 1, wherein the feed assembly comprises a water-gas metal pipe (32), a metal water supply pipe (18) and a metal gas supply pipe (19), the water-gas metal pipe (32) is fixed on an A-type frame (11) of the Eurosilo, the metal water supply pipe (18) and the metal gas supply pipe (19) are arranged on a helical frame (8) of the Eurosilo, the metal water supply pipe (18) and the metal gas supply pipe (19) are connected with the water-gas metal pipe (32) via a pipe joint (35), and the water-gas metal pipe (32) is connected with the first water-gas hose (30).

9. The micro-mist dust suppression device for a coal storage Eurosilo of claim 8, wherein the water-gas metal pipe (32) is provided with a pressure transmitter (31) connected with the micro-mist dust suppression host (27).

10. The micro-mist dust suppression device for a coal storage Eurosilo of claim 1, further comprising a constant torque reel (26) arranged on the revolving trestle (4) of the Eurosilo, and the first water-gas hose (30) being coiled on the constant torque reel (26).
